(19) United States
(12) Patent Application Publication
(10) Pub. No.: US 2009/0200216 A1
(43) Pub. Date: Aug. 13, 2009

(54) STORM DRAIN FILTER

(75) Inventors: Iain Alexander Stewart Robinson, Berwickshire (GB); Colin John Cunningham, Edinburgh (GB)

Correspondence Address: NIXON & VANDERHYE, PC, 901 NORTH GLEBE ROAD, 11TH FLOOR, ARLINGTON, VA, 22203, US

(73) Assignees: Iain Aleander Stewart Robinson, Berwickshire (GB); The University Court of the University of Edinburg, Edinburg (GB)

(21) Appl. No.: 11/913,007

(22) PCT Filed: Apr. 26, 2006
(86) PCT No.: PCT/GB06/01522

§ 371 Date: Jun. 16, 2008

(30) Foreign Application Priority Data
Apr. 27, 2005 (GB) 0508483.5

(51) Int. Cl. C02F 9/02; C02F 9/04; B01D 21/00; E03F 1/00; C02F 9/14

(52) U.S. Cl. 210/85; 210/232; 210/202; 210/254; 210/256; 210/109

(57) ABSTRACT

A treatment station for a water drainage conduit has a chamber with an inlet and outlet in fluid communication with upstream and downstream sections of the conduit and a sediment collection portion. Water enters the chamber via the inlet, collecting in the sediment collection portion until it reaches a level in the chamber such that it flows out of the outlet. A filter is mountable above the sediment collection portion for the upwards-flowing filtration of water passing through the chamber to remove organic contaminants. Access means are provided for removal and replacement of the filter and removal of solid material deposited in the sediment collection portion. The treatment station may also have by pass means which operate where the flow of water exceeds a rate which can flow through the filter and preliminary sediment collection chamber for collecting large quantities of sediment. Uses of the treatment station are also described.

The present invention relates to the provision of a treatment station for use in water drainage systems where contaminated runoff occurs from surfaces for example roofs, roads, vehicle parks, airport runways and other such environments. More specifically the present invention relates to the provision of a treatment station with means for removal of dissolved and free phase organic substances, such as hydrocarbons from vehicles.

In urban and industrial areas and on roadways, because most ground surfaces are sealed, rainwater must be collected and removed by a suitable drainage system. The drainage system must be capable of dealing with a wide range of water flow rates, including storm conditions.

Typically drainage is achieved by the provision of slopes, cambers, gutters etc which collect rainwater on the surface and deliver it to inlets of an underground piped (conduit) drainage system. The drainage system may be part of the local sewerage system or may be a separate system, for example, feeding the storm water directly into a river or the sea.

Usually the rainwater collected by such drainage systems is contaminated by low levels of organic substances, especially hydrocarbons, derived from the use of vehicles. Other organic substances such as pesticides may be present depending on the circumstances. Occasionally the loading of contaminating organic substances is greatly increased e.g. by a spillage of fluids following a vehicle accident.

In general, increased levels of contamination may be expected where vehicles stand for periods of time e.g. car parks.

Unless the water collected by the drainage system is treated to remove these organic contaminants, for example at a sewage treatment works, then the contamination is released into the environment at the outlet from the drainage system, adding to the general burden of pollution. Increasingly it is recognised that such releases of contaminants (even at the typical low levels) from rainwater drainage are problematical and so are controlled by legislation such as the EU Water Framework Directive which is likely to be increasingly restrictive and demand higher treatment standards.

It is an object of the present invention to provide means to reduce the level of or even remove the organic contaminants, especially hydrocarbons, found in water drainage systems, before the water is discharged to a water course or arrives at a treatment works.

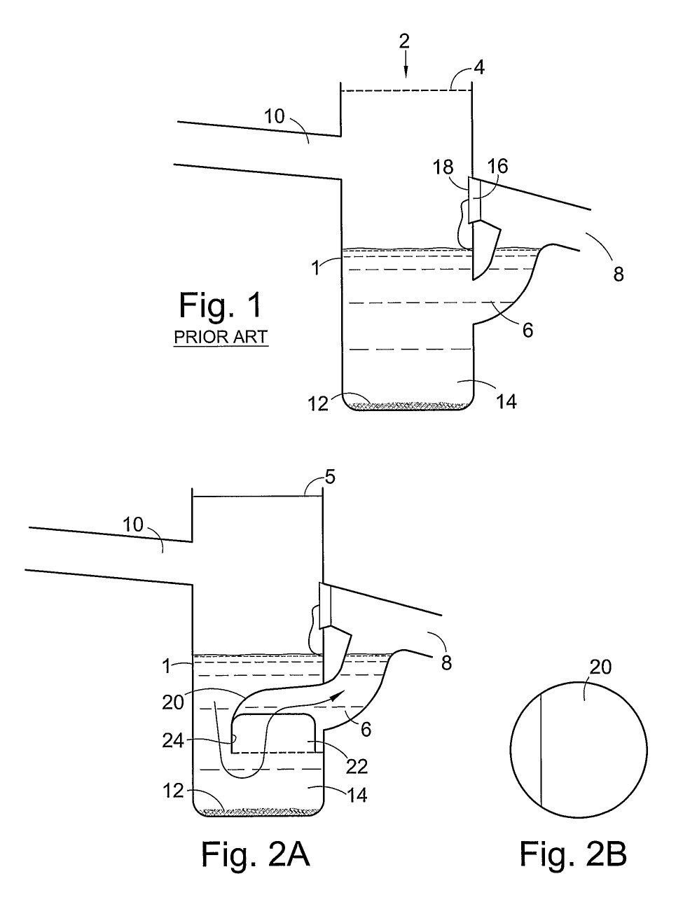

Typical drainage systems include ‘road gullies’ or gully pots. Gully pots such as the typical example shown in FIG. 1 comprise a chamber 1 buried in the ground. Rainwater being collected enters the gully pot chamber via an inlet which is usually the open top 2 of the chamber with a grid 4 to protect the drainage system from large objects or debris falling in. The rainwater then fills the gully pot until it reaches the level where it flows out of the gully pot via the outlet 6 into a drain pipe 8 (conduit). The drain pipe may be fed by a number of such gully pots and the pipe itself may be part of a network of drainage pipes.

The gully pot normally only serves the function of sediment collection. In use sediment such as grit and stones or other debris is washed into the drainage system by the force of the water flow. Such sediments would be liable to gradually silt up or block the drain conduit system. The gully pot largely prevents this by collecting such sediments in its base (sediment collection portion) from where they are periodically removed via the top inlet which serves as access means. For ease of maintenance the gully pot of FIG. 1 also features a “rodding point” 18 protected by a stopper 16 which facilitates the insertion of blockage clearing equipment such as rods or pressure water hoses into the conduit pipe. Typically gully pots are constructed of earthenware, pre-cast concrete or plastics material. Whilst gully pots serve to prevent larger particles, solids or sediments entering the drainage system and flowing to the outlet (sewage works or water course) they do not address, at all, the issue of trace hydrocarbons and other organic materials present in the water collected from roads and urban or industrial environments. A further disadvantage of gully pots is that the solids collected, which tend to contain pollutants such as heavy metals and absorbed organics are not kept from entering the drainage system. In storm conditions the high flow rate and turbulent mixing that occurs through a gully pot tends to flush the accumulated sediments into the drainage conduit system. Similarly any free organic phase such as a hydrocarbon layer from vehicle spillages that may be trapped, floating on the water retained in the gully pot, is likely to be forced through the conduit. Thus a ‘foul flush’ of contaminated water is released into the drainage system from gully pots when heavy rain occurs.

Furthermore small particles, suspended in the water will tend not to settle out in a gully pot but rather remain in the flowing water. In GB2360713 an apparatus for insertion into a gully pot is provided. The apparatus comprises a housing for a filter where drainage water is passed radially through a plurality of filtration media before being discharged into the drainage system. A potential disadvantage of this arrangement is that the filtration media employed can become clogged with the fine particulates suspended in the water. In any case the sediment collecting in the gully pot chamber base will block the lower levels of the filtration media used, rendering them ineffective until the sediment is removed, by periodic cleaning. It is an object of the present invention to provide treatment stations for use in water drainage systems that avoid or at least minimise some of the foregoing problems.

Accordingly the present invention provides a treatment station for a water drainage conduit comprising;

a chamber having inlet and outlet means in fluid communication with upstream and downstream sections of said conduit and a sediment collection portion, said inlet and outlet means and sediment collection portion being formed and arranged so that, in use, water enters the chamber via the inlet means collecting in the sediment collection portion until it reaches a level in the chamber such that it flows out of said outlet means; wherein said chamber is provided with a filter means mount for releasably mounting, in use of the treatment station, a filter means above the sediment collection portion for the upwards flowing filtration of water passing through the chamber to remove organic contaminants; and said treatment station is further provided with access means for removal and replacement of said filter means and the removal of solid material deposited in said sediment collection portion.

A particular benefit obtained by arranging the filter for upwards filtration is that the heavier particles and any other debris (generally all solids significantly denser than water and with a reasonable particulate size) present in the drain water are deposited in the sediment collection portion before the water contacts and passes upwardly through the filter. Typically up to 80% of the particulates present are removed by the filter. Unlike the particulates collected by gully pot arrangements these accumulating particulates are not flushed through the system in storm conditions but are retained by the action of the filter allowing them to be treated in situ, or removed for treatment and/or disposed. Furthermore fine particulates, which tend to remain suspended in the water, until they are filtered out by the filter, are much less likely to clog or ‘blind’ the filter medium employed during upwards filtration as they will tend to fall off the filter back into the sediment collection portion thereby allowing further treatment to be applied as well as capturing particulates-bound contaminants e.g. heavy metals. In prior art filtration arrangements such as the radial filtration device of GB2360713 the filter may tend to become clogged by sediments and fine suspended particulates. This will lead to the tendency of the contaminated water to by-pass the filter, finding the easiest path to the outlet.

The filter means mount can be any means of securely but releasably attaching the filter to the treatment station. For example the mount could be a lug or lugs on the chamber walls to which the filter is attached by means of releasable fasteners such as screws or bolts, or which provide a bayonet or like form of coupling for releasable inter engagement with suitable formations on a filter cartridge or the like. Alternatively the mount may comprise a housing, box or cage like structure, formed and arranged to permit water flow therethrough, into which filter media or a filter element or elements is/are located and secured. In some cases the filter means used with the treatment station of the invention may itself comprise a housing, box or cage containing filter media i.e. a filter cartridge. In such cases the filter means mount comprises means of attaching and securing the filter cartridge to the gully pot chamber such as the aforementioned lugs.

In use the filter media employed in the filter gradually becomes saturated with organic substances and has to be replaced. The treatment station therefore requires access means for removal and replacement of the filter. Conveniently the access means simply comprises the top of the chamber, which is typically fitted with a removable or hinged grille to prevent ingress of large debris. In embodiments where the top of the treatment station chamber is not an inlet for drainage water, and not fitted with a removable grille, then a removable manhole type cover fitted to the chamber top can provide the access means.

Preferably, in order to maximise the time interval between filter changes the filter size should be as large as possible, so that for a given filter medium employed, the filter surface area available to trap or absorb the organic contaminants is maximised. In a preferred embodiment the filter means mount holds a filter means which covers the whole cross-sectional area of the chamber above the sediment collection portion, which is a bottom portion of the chamber. In such an embodiment the inlet means comprises a pipe entering the chamber at a point below the filter means mount and the filter (when fitted). This allows the sediment to collect in the sediment collection portion before the drainage water flows up through the filter and leaves the chamber by the outlet means.

The flow capacity of the treatment station of the invention depends on the size of the inlet means, outlet means and chamber and also on the permeability of the filter fitted to the filter mount. In storm conditions the treatment station may not be able to cope with the water flow. Similarly, when the permeability of the filter is reduced, for example, when the chamber is filled with sediment or the filter employed becomes partially blocked by fine particulates, then flow may exceed the capacity of the treatment station and its associated filter.

Preferably the treatment station further comprises by-pass means for the flow of water through the conduit without passing through a filter means mounted on the filter means mount, said by-pass means being formed and arranged to operate where the flow of water exceeds a rate which can flow through said filter means in use thereof. For example, in an embodiment where the inlet means comprises a pipe entering the chamber below the filter, the by-pass means may comprise a pipe loop connecting the inlet pipe directly to the conduit, after the treatment station formed and arranged to take water flow when flow in the inlet pipe is excessive or the filter means is blocked. For example the pipe loop may include a weir, or a slight rise contrary to the general fall direction of the conduit, which prevents water entering the pipe loop under normal flow conditions. Other arrangements and forms of by-pass means can be envisaged and some are described later in the detailed description of some preferred embodiments.

Suitable filter media for the absorption of organic substances, especially hydrocarbons such as those resulting from vehicle operations, are known in the art, especially from one or more of U.S. Pat. Nos. 5,437,793, 5,698,139, 5,746,925 and 6,180,010. Preferred filter media materials are commercially available from Mycelx® Technologies Corporation, Gainesville, USA, which incorporate polymeric surfactants that bind hydrocarbons and a wide range of other organic pollutants.

In tests using the Permakleen filter product from Mycelx the material showed the ability to remove a very high percentage (99.8%-99.9%) of hydrocarbons from a water sample heavily loaded (40 g L⁻¹) with petrol, diesel or used engine oil. The treatment station of the invention, when fitted with a suitable filter can therefore act to trap the bulk of a substantial hydrocarbon spillage, preventing most of the contaminant from passing further through the drainage system.

A field trial on actual waste water containing <5 ppm of Total Petroleum Hydrocarbons (TPH) demonstrated the ability of a Permakleen filter to reduce TPH levels to <1 ppm during a 3 month period. It was also noted that suspended solids present in the waste water were also removed by the filtration process with a 50% to 82% efficiency. Removal of suspended solids at the treatment station is a further benefit of the invention.

It will be appreciated that the treatment station of the invention can be constructed to any suitable size, depending on the capacity of the drainage system to which it is fitted. However a typical installation can be of a size comparable to that of gully pot chambers, where only a relatively small volume of drain water is to be treated. Such an installation may be employed, for example in a car park, at or after the last water collection point in the car park, to intercept hydrocarbon or other contaminants before they enter the watercourse or component of the drainage system.

Typically the chamber of the treatment station will be of approximately 750 mm diameter. A filter comprising Mycelx type material fitted to such a chamber has the capacity to absorb the trace hydrocarbons etc from a substantial volume of water. Thus such a filter can be used for long periods of time before requiring replacement.

However the filter media employed in the treatment stations of the invention will also filter out up to 80% of the particulates (suspended or nearly suspended solids) found in the drainage water. When the treatment station is employed in a drainage system where large volumes of water from substantial areas of ground surface (roads, car parks etc), are dealt with, the sediment collection portion is liable to fill quickly with both the heavier and larger debris and the finer particulates filtered out of the water as it is upwardly filtered by the filter means. Tests utilising Mycelx as a filter medium have shown that most particles with a size greater than 60 μm can be filtered out of a water flow. In order to avoid the need to frequently empty the sediment collection portion of the chamber of the treatment station, the treatment station, in another aspect of the invention, preferably comprises a preliminary sediment collection chamber, upstream of the chamber with the sediment collection portion and filter means mount.

The preliminary sediment collection chamber generally comprises an inlet in fluid communication with the upstream section of the drainage conduit, an outlet in fluid communication with the inlet of the chamber with the sediment collection portion and access means for maintenance and the removal of accumulated sediment. Preferably the preliminary sediment collection chamber further comprises a collection basket, formed and arranged so as to, in use of the treatment station, collect debris entering said sediment collection chamber via the inlet.

Preferably the outlet of the preliminary sediment collection chamber further comprises a filter means, formed and arranged so as to, in use of the treatment station, prevent solids leaving via the outlet.

The preliminary sediment collection chamber performs the function of collecting most solids present in the water flow of the drainage conduit before the water flow enters the solids collecting portion of the chamber containing the filter means mount. This has the benefit of keeping the relatively small solids collecting portion of the filter containing chamber at least substantially free of sediment, allowing long intervals between maintenance. Advantageously the sediment collecting chamber is substantially larger then the chamber with the filter means mount. For example the sediment collecting chamber may be of the order of 10,000 litres capacity when used to collect sediments from the water flows resulting from the drainage of 1.5 km of roadway. This large capacity means that removal of sediments need only be carried out at relatively long time intervals.

Preferably the filter means for the outlet of the sediment collection chamber comprises a slotted pipe, in fluid communication with the outlet, said pipe being most preferably coated in a water permeable filter membrane such as, for example, a geotextile membrane. Geotextile membranes are well known in the art and are typically used, to allow water to flow into a drainage conduit without allowing particulates such as soil or sand grains to enter.

Advantageously the treatment stations of the invention may be fitted with at least one sensor to monitor water flow or condition. The sensor or sensors can determine the water flow through the treatment station and/or analyse for contaminants in the water. The sensor or sensors are fitted at appropriate locations to monitor the desired parameters. For example, water flow may be measured in the drainage conduit, at or just before the inlet to the sediment collection chamber, at the outlet from the sediment collection chamber and also at the outlet from the chamber with the sediment collection portion. Monitoring flow at these points allows a determination of the variation in flow rate through the treatment station to be made. When the flow rate reduces, due to a build up of filtered particulates, then the sediments can be removed and filters replaced as required. Sensors can also be used to monitor for the presence of pollutants in the water flow and to trigger an alarm condition when an excess of pollutant is detected.

As the treatment station may be at a remote location, the output from the sensor or sensors may be relayed to a monitoring station by means of wireless communication, for example, by using a mobile phone communications network, which connects to a mobile phone or a computer, via the Internet. The power supply for the sensors and communication system may conveniently be supplied by a solar panel, for example.

Preferably the treatment station is provided with a shut off valve operable in response to a signal from a sensor. For example, the shut off valve stops flow in the drainage conduit, downstream of the treatment station, when a substantial quantity of pollutant is detected (i.e. at a level greater than the treatment station can deal with) by a sensor. For example, the pollutant may be hydrocarbons from a fuel spillage. The operation of the shut off valve prevents the spillage continuing down the conduit and gives time for a clean up operation to be undertaken at the treatment station. The shut off valve may take the form of an inflatable bladder which is inflated, by air or water pressure, so as to close the conduit and prevent flow.

A key feature of the present invention is the retention of sediments in the preliminary sediment collection chamber, where fitted, and/or the sediment collection portion allowing biological or chemical treatment or treatments to be applied in situ. The sediments collected by a surface water drainage system can contain a number of potentially harmful or at least undesirable components such as heavy metals, chlorides etc. Adding a suitable sequestering agent or agents to the preliminary sediment collection chamber or sediment collection portion can effectively prevent these harmful components leaching out into the water flow. Furthermore effective sequestration of undesirable species in the sediments collected can make the disposal of the sediments easier. For example they may be disposable in a landfill without further treatment. Examples of treatments that may be applied depending on site specific conditions include but are not limited to apatite minerals, iron oxides, agents in liquid or solid form to precipitate or otherwise transform contaminants, free or immobilised microorganisms and/or compounds to assist in biological transformation or degradation of contaminants. Such treatments in addition to rendering the retained sediment less hazardous or toxic and more amenable to re-use such as a fill material will also treat dissolved or free phase contaminants in the water. For some applications mixing or aeration may be introduced into the primary sediment collection chamber by connection to a fixed power supply or utilising solar or wind powered generation.

Further preferred features and advantages of the present invention will appear from the following detailed description of some embodiments illustrated with reference to the accompanying drawings in which:

FIG. 1 is a schematic representation of a conventional gully pot for sediment collection in a drainage system;

FIGS. 2A and 2B show elevation and plan views of an embodiment of the treatment station of the invention where the filter means mount is a housing;

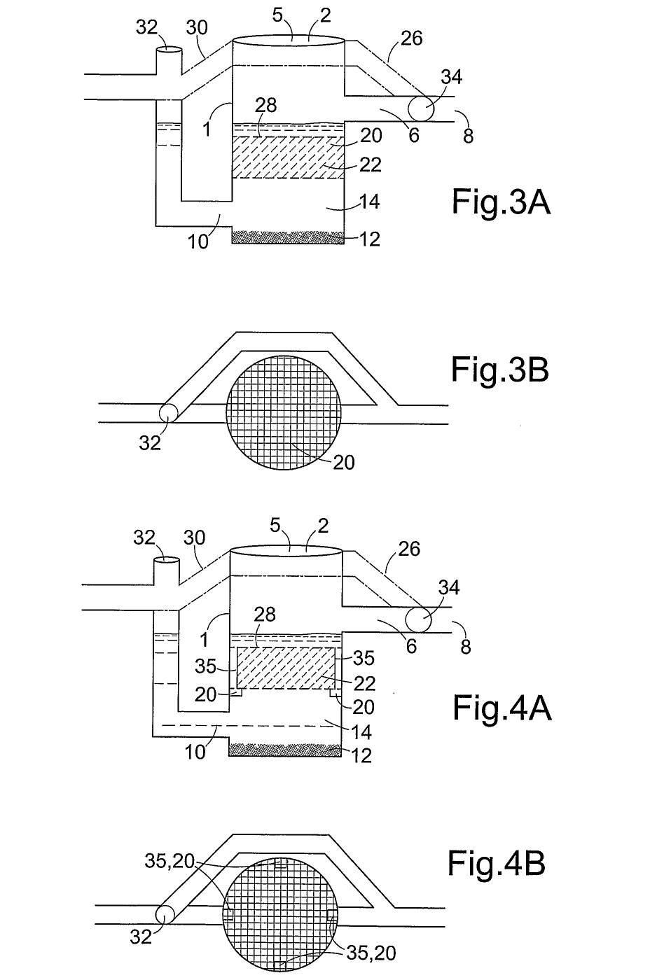

FIGS. 3A and 3B show schematically elevation and plan views of another embodiment with inlet means, comprising a pipe, and by-pass means;

FIGS. 4A and 4B show schematically elevation and plan views of a further embodiment generally the same as in FIGS. 3A and 3B but with an alternative filter means mount; and

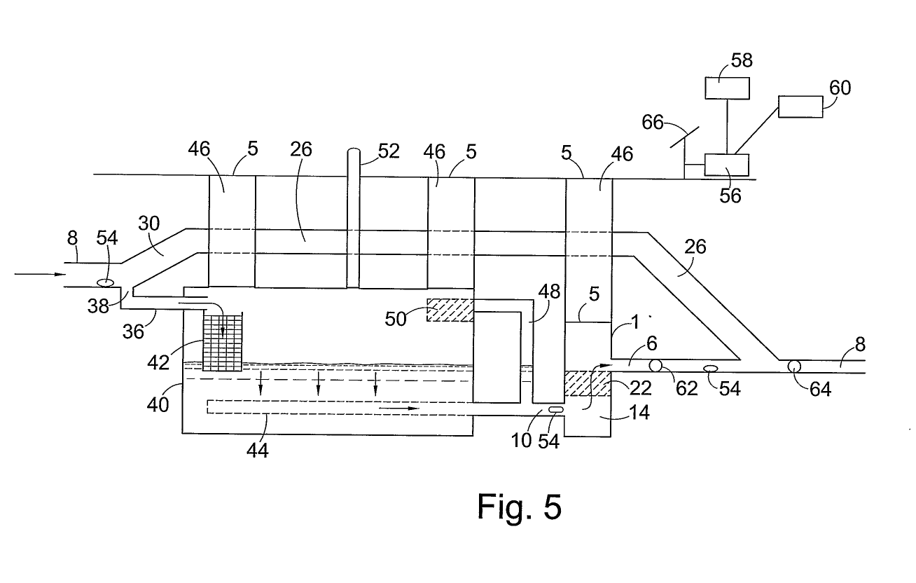

FIG. 5 shows schematically yet another embodiment of the invention including a sediment collection chamber.

The conventional gully pot shown in FIG. 1 collects water in the chamber 1 entering from the open top inlet 2, which has a grid 4 to prevent large object falling in. Water rises in the chamber 1 until it flows out of the outlet 6 into the conduit (pipe) 8. In this example the gully pot is also fitted with another inlet means, the pipe 10 delivering water from elsewhere in the drainage system. Sediment 12 collects in the sediment collecting portion 14, the base part of the pot. In this typical embodiment the outlet 6 is in the form of a rising pipe. In use water remains at the level shown, when there is no flow and acts to prevent offensive odours coming back out of the conduit 8, which leads to part of a sewage system. A releasable bung 16 covers a port for access to clear blockages in the conduit.

In FIGS. 2A and 2B an embodiment of the treatment station of invention is shown in elevation and plan views, with parts corresponding to those shown in the gully pot of FIG. 1 numbered concordantly. The treatment station has a filter means mount 20 for holding a filter 22. The mount 20 holds the filter in position above the sediment collection portion and at or below the outlet 6. The mount 20 comprises a housing made for example of plastics material or metal which is itself releasably attached to the wall of the chamber. The mount (housing) has a grid 24 on its base which permits water flow into and up through the filter in the direction generally indicated by the arrow. In use water flowing into the treatment station via the inlet 10 deposits sediment 12 into the sediment collecting portion 14 before flowing upwards through the filter 22, where organic pollutants are removed, and out into the conduit. To change the filter access is gained by removing the lid 5 fitted at road level to the top of the chamber, which is the access means in this embodiment. The filter mount (housing) 20 is removed from the treatment station and the filter therein replaced as required.

FIGS. 3A and 3B show a preferred embodiment of the invention in elevation and plan views. In this embodiment the filter means mount 20 is a cage, which may be of a plastics or metal construction. The cage fills the complete cross-section of the fully pot chamber 1 and is sited above the sediment collection portion 14 and below the outlet 6. The inlet 10 is a pipe leading into the gully pot at the sediment collection portion 14 i.e. below the filter means mount (cage) 20. Also provided in this particular example is a by-pass means 26 which consists of a pipe loop in fluid communication with the inlet pipe 10 and the conduit 8 before and after the gully pot respectively. In use, a filter 22 comprising a medium such as, for example Mycelx™ Permakleen contained in a permeable bag, is placed via an opening lid 28 in the mount (cage) 20. Access to the mount (and the sediment 12) is via a manhole cover 5 on the top opening 2 of the treatment station. A ‘rodding eye’ 32 is provided to facilitate removal of blockages and can also provide alternative access for removal of the sediment 12. Under normal (i.e. not excessive) rainfall conditions water flows into the treatment station via the inlet pipe and deposits sediment 12 in the base, which is the sediment collection portion 14. As the chamber fills the flowing water is filtered by a filter 22 located in the mount (cage) 20, before leaving the treatment station via the outlet 6. When rainfall is high or the flow through the filter is reduced the inlet pipe no longer has the capacity to accept all of the incoming water and water overflows the rising portion 30 (shown with an exaggerated slope for clarity) of the by-pass 26 pipe loop, rejoining the conduit at junction 34.

It will be appreciated that other means of controlling the operation of the by-pass can be envisaged, such as the provision of a weir or simply by having an inlet pipe of such a diameter that in storm conditions the inlet pipe is filled with water and the bulk of the flow is round the by-pass pipe loop.

It will be appreciated that during storm conditions, when the by-pass 26 is operating the concentration of organic pollutants is greatly reduced, by dilution with the excess water. In such conditions removal of the organic pollutants from the water is less important and desired or legislative limits on the concentration of organic pollutants are likely to be met by the water discharged from the conduit.

FIGS. 4A and 4B show an embodiment generally of the same construction as that of FIGS. 3A and 3B except that the filter 22 is in the form of a cartridge i.e. a unit comprising filter media in a housing, in this case a cage. The filter means mount 20 takes the form of lugs position round the circumference of the chamber as shown in the plan view. The filter 22 cartridge is secured to the lugs by releasable fasteners such as screws, nuts and bolts or bayonet type couplings, accessible via holes 35 in the filter cartridge body.

In FIG. 5 a treatment station of the invention comprising a preliminary sediment collection chamber is illustrated schematically with the normal direction of flow indicated by arrows. In this embodiment water flowing in the conduit 8 flows via a pipe 36 which has a bottom entry 38 from the conduit into a large preliminary sediment collection chamber 40. Large debris is collected in a filter basket 42 with sediments collecting in the chamber by settling and by virtue of being filtered from the water flow by the slotted or pierced pipe 44 which is coated or wrapped in a geotextile membrane or other suitable filter medium. After filtration at the pipe 44 the water flows out of the sediment collection chamber 40 into the sediment collection portion 14 of the chamber 1, where it flows up through the filter 22 and out through the outlet 6 to rejoin the drainage conduit 8.

Debris collected in the basket 42 and sediment collected in the chambers 1, 40 can be removed via the access means 46 which are fitted with lids 5. The sediment collection chamber 40 is, in this example, also provided with an additional outlet pipe 48 which operates in conditions where the rate of flow out through the pipe 44 is less than the inlet flow through the pipe 36. Flow from the outlet pipe 48 is filtered by the replaceable filter 50, which may be of the same type as the organic substances removal filter 22. The pipe 48 connects to the inlet 10 of chamber the chamber 1.

In storm conditions a bypass means 26 operates, in this example it is a pipe with rising section 30 as previously described for the treatment station of FIG. 3.

The sediment collection chamber 40 is also provided with an air vent 52.

Sensors 54 for monitoring flow rate and/or the presence of pollutants are fitted to the treatment station. The sensors are located in the main conduit 8 at just before the pipe 36 leading into the preliminary sediment collection chamber 40, in the pipe 10 connecting the sediment collection chamber 40 and the chamber 1 and in the outlet pipe 6. These sensors 54 are connected to a central monitor box 56 (connections not shown for clarity), which relays the information by means of a mobile phone network to a mobile phone 58 or computer 60. A hydrocarbon sensor 62, to detect the presence of substantial quantities of hydrocarbon pollutant, is located in the outlet pipe 6. It also communicates with the monitor box 56. A shut off valve 64, which in this example takes the form of an inflatable bladder, is fitted to the conduit 8 at a point downstream of the rest of the treatment station. The power supply for the sensors 54, 62 and the shut off valve 64 is provided by solar panel 66. In use the sensors 54 and the hydrocarbon sensor 62 monitor the water flow and for the presence of hydrocarbons and report via the monitor box 56 to the mobile phone 58 or computer 60, where an operator can determine if any action such as sediment removal or filter replacement is required. If a substantial quantity of hydrocarbons are detected by the sensor 62 then the shut off valve 64 operates preventing flow further along the conduit 8 and an alarm signal is sent to the mobile phone or computer to inform an operator of the emergency.

It will be appreciated that various modifications may be made to the above described embodiments without departing from the scope of the invention.

1-28. (canceled)

29. A treatment station for a water drainage conduit comprising; a chamber having inlet and outlet means in fluid communication with upstream and downstream sections of said conduit and a sediment collection portion, said inlet and outlet means and sediment collection portion being formed and arranged so that, in use, water enters the chamber via the inlet means collecting in the sediment collection portion until it reaches a level in the chamber such that it flows out of said outlet means; wherein said chamber is provided with a filter means mount for releasably mounting, in use of the treatment station, a filter means above the sediment collection portion for the upwards flowing filtration of water passing through the chamber to remove organic contaminants; and said treatment station is further provided with access means for removal and replacement of said filter means and the removal of solid material deposited in said sediment collection portion; said treatment station further comprising a preliminary sediment collection chamber, upstream of the chamber with the sediment collection portion and filter means mount.

30. A treatment station according to claim 29 wherein the preliminary sediment collection chamber is substantially larger than the chamber with the sediment collection portion and filter means mount.

31. A treatment station according to claim 29 wherein the preliminary sediment collection chamber comprises an inlet in fluid communication with the upstream section of the drainage conduit, an outlet in fluid communication with the inlet of the chamber with the sediment collection portion and access means for maintenance and the removal of accumulated sediment.

32. A treatment station according to claim 29 wherein the preliminary sediment collection chamber further comprises a collection basket, formed and arranged so as to, in use of the treatment station, collect debris entering said sediment collection chamber via the inlet.

33. A treatment station according to claim 29 wherein the preliminary sediment collection chamber further comprises a filter means formed and arranged so as to, in use of the treatment station, prevent solids leaving via the outlet.

34. A treatment station according to claim 33 wherein the filter means for the outlet of the preliminary sediment collection chamber comprises a slotted pipe, in fluid communication with the outlet.

35. A treatment station according to claim 34 wherein the slotted pipe is coated in a water permeable filter membrane.

36. A treatment station according to claim 35 wherein the water permeable filter membrane is a geotextile membrane

37. A treatment station according to claim 29 for the collection of sediments and the upwards flowing filtration of water to remove organic contaminants.

38. A treatment station according to claim 37 wherein biological or chemical treatments are carried out in situ on the sediments collected.

39. A treatment station according to claim 37 wherein at least one sequestering agent is added to the preliminary sediment collection chamber and/or the sediment collection portion.

40. A treatment station according to claim 38 wherein the contents of the preliminary sediment collection chamber are mixed or aerated.

41. A treatment station for a water drainage conduit comprising; a chamber having inlet and outlet means in fluid communication with upstream and downstream sections of said conduit and a sediment collection portion, said inlet and outlet means and sediment collection portion being formed and arranged so that, in use, water enters the chamber via the inlet means collecting in the sediment collection portion until it reaches a level in the chamber such that it flows out of said outlet means; wherein said chamber is provided with a filter means mount for releasably mounting, in use of the treatment station, a filter means above the sediment collection portion for the upwards flowing filtration of water passing through the chamber to remove organic contaminants; and said treatment station is further provided with access means for removal and replacement of said filter means and the removal of solid material deposited in said sediment collection portion.

42. A treatment station according to claim 41 wherein the filter means mount comprises a lug or lugs on the wall of said chamber to which a said filter means is attached, in use, by releasable fasteners.

43. A treatment station according to claim 41 wherein the filter means mount comprises bayonet couplings for releasable inter engagement with suitable formations on a filter cartridge.

44. A treatment station according to claim 41 wherein the filter means mount comprises a housing, box or cage like structure, formed and arranged to permit water flow therethrough and to hold, in use, filter media or a filter element.

45. A treatment station according to claim 41 wherein the access means for removal and replacement of said filter means is a removable and/or hinged grille or cover provided in the top of the chamber.

46. A treatment station according to claim 41 wherein the filter means mount holds, in use, a filter means which covers the whole cross-sectional area of the chamber above the sediment collection portion, which is a bottom portion of the said chamber and the inlet means comprises a pipe entering the chamber at a point below the filter means mount and the filter means.

47. A treatment station according to claim 41 which further comprises by-pass means for the flow of water through the conduit without passing through a filter means mounted on the filter means mount, said by-pass means being formed and arranged to operate where the flow of water exceeds a rate which can flow through said filter means in use thereof.

48. A treatment station according to claim 47 wherein the bypass means comprises a pipe loop connecting the inlet pipe directly to the conduit, after the treatment station, formed and arranged to take water flow when flow in the inlet pipe is excessive and/or the filter means is blocked.

49. A treatment station according to claim 48 wherein the pipe loop includes a weir or a slight rise contrary to the general fall direction of the conduit.

50. A treatment station according to claim 48 wherein the inlet means to the chamber of the treatment station is a pipe of a diameter such that in storm conditions the inlet pipe is filled with water and the bulk of the flow is round the by-pass pipe loop.

51. A treatment station according to claim 41 further comprising at least one sensor to monitor water flow and/or condition.

52. A treatment station according to claim 51 wherein said at least one sensor is formed and arranged to monitor, in use, for the presence of pollutants in the water flow and to trigger an alarm condition when an excess of pollutant is detected.

53. A treatment station according to claim 51 wherein the treatment station further comprises wireless communication means formed and arranged for relaying the output from said at least one sensor to a monitoring station.

54. A treatment station according to claim 51 further comprising a solar panel for the supply of power to said sensor and/or communication means.

55. A treatment station according to claim 51 further comprising a shut off valve, operable in response to a signal from a said at least one sensor and formed and arranged to stop flow in the drainage conduit downstream of the treatment station.

56. A treatment station according to claim 55 wherein the shut off valve comprises an inflatable bladder.

57. A treatment station according to claim 41 for the collection of sediments and the upwards flowing filtration of water to remove organic contaminants.

58. A treatment station according to claim 57 wherein biological or chemical treatments are carried out in situ on the sediments collected.

59. A treatment station according to claim 57 wherein at least one sequestering agent is added to the sediment collection portion.
